(19) United States
(12) Patent Application Publication
(10) Pub. No.: US 2008/0292263 A1
(43) Pub. Date: Nov. 27, 2008

(54) Accessibility of Graphics During and After Trick Play

(75) Inventor: Wilhelmus Jacobus Van Gestel, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,608

(22) PCT Filed: Jul. 13, 2005
(86) PCT No.: PCT/IB2005/052323

§ 371 Date: Jan. 24, 2007

(30) Foreign Application Priority Data
Jul. 27, 2004 (EP) 04103595.7

(51) Int. Cl. H04N 5/93

(52) U.S. Cl. 386/52

(57) ABSTRACT

A method is disclosed of authoring a digital video signal comprising graphics content in a multiplex stream. The method comprises constructing the signal during authoring, the graphics content being exclusively multiplexed into the frame of a first type of image multiplexed into the stream. This enables improved trick play of said signal when only said first type of images is read from the stream. Thus, the graphics content is also available during trick play and immediately after trick play when returning to normal play.

### FIELD OF THE INVENTION

This invention relates in general to the field of digital signals. More particularly the invention relates to digital video signals comprising graphics content in addition to images, and even more particularly to improved graphics to be made available from a digital video stream during and after trick play of such a digital video stream signal.

### BACKGROUND OF THE INVENTION

Generally, the term “trick play” refers to playback modes of video signals such as Slow/Fast Forward/Reverse at various speeds in relation to nominal speed at normal playback of the video signals.

Tape-based analog video recorders are currently being replaced by digital video recorders, also called Digital Personal Video Recorders (PVR), based on either hard disks or optical discs as storage media. The consumer still expects the familiar trick play modes to be available, but the techniques used in VHS are no longer applicable. The digital video recorders and DVD players currently on the market play back over an analog interface to a conventional TV. Playback over a digital interface is becoming an important feature, especially in the context of fast-growing digital networks.

Furthermore, the video content is enhanced with interactive content, for example in the field of interactive television. PVRs offer the user using the transport controls such as pause, instant replay, rewind etc. to access the “trick play” modes. These operations can also be performed whilst watching live TV, in contrast to conventional video recorders.

Playing back over a digital interface introduces a problem for trick play, because the device receiving and decoding the stream will in general not know it is receiving a trick play stream. The receiving device will expect a normal video stream complying with the same format as for normal play.

MPEG (Moving Pictures Experts Group) is a group of experts that meet under the ISO (International Standard Organization) to generate standards for digital video and audio compression. The MPEG-2 Standard has made it practical to use compressed digital video signals in such consumer products. MPEG-2 is designed for the generic coding of moving pictures and associated audio and creates a video stream out of three types of frame data (intra frames I, forward predictive frames P, and bidirectional predicted frames B) arranged in a specified order called the GOP structure (GOP=Group Of Pictures). There are many possible GOP structures, but a common one is 12 or 15 frames long, (as a GOP is often about 0.5 sec, which for 50 Hz systems results in 12 frames or for 60 Hz systems in 15 frames) and has the sequence I_BB_P_BB_P_BB_P_BB_P_BB_P_BB_. The ratio of I, P and B pictures in the GOP structure is determined by the nature of the video stream and the bandwidth constraints on the output stream. The GOP structure starts with an Intra picture (I-picture). The I-picture is coded without reference to the other pictures. The I-pictures also provide access points in the bit-stream where coding begins. The P-picture has a reference to the previous I-picture or P-picture. This P-picture can only be decoded if this previous I-picture or P-picture has already been decoded. The B-picture contains references to the previous I or P-picture and to the next P or I-picture. The average amount of bits for the encoded picture is highest for the I-picture and lowest for the B-picture.

Moreover, the above-mentioned graphics data is multiplexed as an elementary stream in the above-described main MPEG2 Transport Stream (TS). The graphics data is e.g. used for presenting menus, wherein the contents e.g. of the menus might be different at different locations in the stream or e.g. for presenting subtitles.

During trick play not all data of the stream is read as the transfer rate from disc is limited and the rate during normal play is high already. A rate higher than the normal playing rate for enabling trick play is often not possible. Therefore, trick play is realized by reading only parts of the stream, e.g. the I-pictures only, and displaying these parts at normal playing speed. Assuming a GOP length of 12 frames and a Fast Forward speed of 3 times normal speed (3×), only the I-pictures are read and presented. These pictures are repeated 4× during presentation. Thus, virtually trick play is made feasible, offering the user the expected experience with only the video information played faster. However, this means that parts of the stream are not read during trick play modes. According to the prior art, parts of the graphics elementary stream are not read. If parts of the data are missing, then the whole data cannot be used. Hence, a problem to be solved by the present invention is that during conventional trick play the graphics data is missing.

Furthermore, after changing conventionally from trick play to normal play, the interactive graphics is not yet present. This is due to the fact that the acquisition points for the graphics stream cannot be repeated too often, as this would increase the bit rate of the main multiplex too much. This means that the contents of the menus based on the graphics from the graphics stream is not present for a certain amount of time. Especially after going to normal play, users often want to see the menu in order to change playback. Any time delays are experienced as inconvenient by the user. It is a further object of the present invention to overcome this drawback.

Some transmission formats for digital video signals require that the graphics information, i.e. presentation graphics and interactive graphics, is transmitted in advance in a transport stream, prior to the associated images. In addition to the above problems, this leads to a drawback resulting in the same inconveniences for the user as described above, i.e. non-availability of graphics during trick play and a delayed display of graphics when returning from trick play to normal play.

Generally, presentation graphics is e.g. subtitling information, but it may alternatively be a picture in a bit map presentation. The interactive graphics in general represent menus comprising buttons and bitmap presentations of pictures.

A different graphics stream is multiplexed in the main multiplex for each language. Presentation of the graphics starts at the same time for each language. That is why averaging of the bit stream is applied, as without the averaging an undesired peak would occur in the bit rate of the main multiplex. The averaging is the reason why the graphics information is sent in advance, actually up to one minute in advance.

As mentioned above, most implementations of trick play only read the I-frames of the main multiplex. For this purpose there is a CPI (Characteristic Point Information) Table with the location of the start and the end of the I-frames. The transport stream packets from the other frames are skipped during trick play. This means that during trick play only some packets from the graphics stream are read, the others are skipped. This makes the graphics stream useless. After resuming normal play the user has to wait until a new graphics is transmitted in the stream before graphics can be presented again. Hence, the user has to wait for the presentation time, because the graphics is transmitted in advance, which may be up to one minute, as mentioned above. This time delay is not acceptable to a user and has to be overcome.

Hence, a further object of the present invention is to enable the accessibility and availability, e.g. for presentation, of the entire (presentation and interactive) graphics from the TS even during trick play and immediately after normal play has been started again after trick play.

### SUMMARY OF THE INVENTION

The present invention overcomes the deficiencies in the art identified above and solves at least the above problems singly or in combination by providing a method of authoring a digital video signal, a trick play method for a digital video signal, apparatuses for performing these methods, computer-readable media comprising computer-executable programs for performing these methods, and a digital video signal according to the appended patent claims.

The present invention proposes to multiplex the graphics data only, i.e. exclusively, in that part of a video multiplex stream where the frames to be displayed during trick play are multiplexed.

According to a preferred embodiment, the graphics data is multiplexed in the main multiplex only at locations where there are I-frames in the multiplex. This data is read during trick play, so all the graphics data is read too and is available for further processing and displaying. According to the invention, it is provided that the information from the graphics data in the graphics stream can be presented during trick play and immediately after trick play as no TS packets with graphics contents are missing during these phases.

According to one aspect of the invention, a method is provided for authoring a digital video signal comprising graphics content in a multiplex stream. The method comprises constructing the signal during authoring, the graphics content being multiplexed into the frame of a first type of image multiplexed into the stream. Preferably, the digital video signal is a MPEG-2-compatible signal, and the first type of image is an I-picture coded without reference to other pictures in the stream. Preferably, the graphics is presentation graphics, such as subtitles, or interactive graphics, such as menus.

According to another aspect of the invention, a further method is provided for trick play of a digital video signal comprising interactive content authored according to the method disclosed above. The trick play method comprises the use, during trick play, of a selected number of images of a first type from a source multiplex stream as a source for displaying said trick play. The interactive content is multiplexed into said first type of images.

According to yet another aspect of the invention, an apparatus for authoring a digital video signal comprising graphics content in a multiplex stream is provided. The apparatus is adapted to perform the above authoring method.

According to a yet further aspect of the invention, an apparatus for trick play of a digital video signal comprising graphics content is provided. The apparatus is configured to perform the above trick play method.

According to a further aspect of the invention, a computer-readable medium is provided having embodied thereon a computer program for processing by a computer. The computer program comprises code segments for authoring a digital video signal comprising graphics content in a multiplex stream, said computer program being configured to perform the authoring method disclosed above.

According to another aspect of the invention, a computer-readable medium is provided having embodied thereon a computer program for processing by a computer. The computer program comprises code segments for trick play of a digital video signal comprising graphics content in a multiplex stream, said computer program being configured to perform the trick play method disclosed above.

According to a yet further aspect of the invention, a signal for a digital video signal comprising graphical content is provided. The signal comprises a selected number of coded images of a first type in a transport stream, the graphical content being multiplexed into said first type of images.

According to a final aspect of the invention, a digital storage medium comprising the signal disclosed above is provided.

The present invention has the advantage over the prior art that it improves the presentation of graphics by making accessible graphics data during and immediately after trick play. The implementation cost is minimal. It is realized during authoring. During playback the continuity counters of the elementary streams are monitored. Once it is known that no TS packets are missing, the graphics can be decoded.

### BRIEF DESCRIPTION OF THE DRAWINGS

Further objects, features, and advantages of the invention will become apparent from the following description of embodiments of the present invention, reference being made to the accompanying drawings, in which

FIG. 1 is a schematic illustration of the creation of a displayed picture consisting of a video picture and a graphics picture from a video stream and a graphics stream,

FIG. 2 is a schematic illustration of the transport and presentation of I-B-P video pictures as a function of time from a multiplexed video stream,

FIG. 3 is a schematic illustration of an exemplary transport stream that contains transport stream packets from one video elementary stream, two audio elementary streams, one interactive graphics elementary stream, one subtitling elementary stream, and SI/PSI transport stream packets,

FIG. 4 is an illustration of the corresponding presentation time of the video frames and graphics picture,

FIG. 5 is a schematic illustration of a multiplex in an embodiment of the video signal according to the invention,

FIG. 6 is a schematic illustration of the creation of an MPEG Transport stream from stored data, and

FIG. 7 is a schematic illustration of a playback system during trick play.

### DESCRIPTION OF EMBODIMENTS

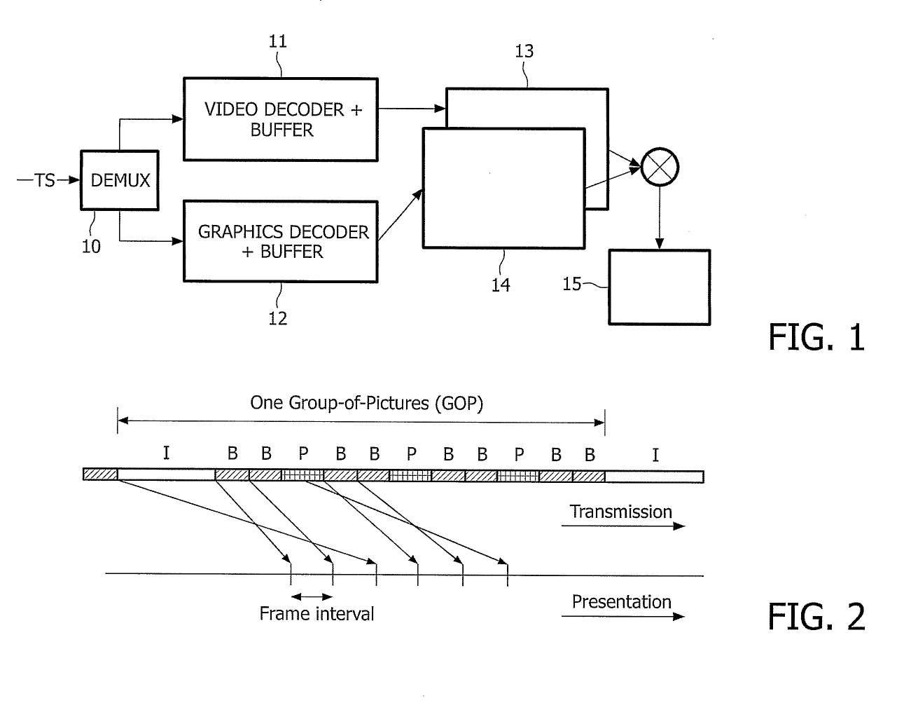

FIG. 1 schematically illustrates in general how a displayed picture 15 is produced from a transport stream TS, the picture P consisting of a video picture and a graphics picture. This principle applies both to normal play and to trick play. The Demux 10 filters the elementary streams, i.e. streams with the same PID number, from a transport stream TS, e.g. an MPEG-2 stream. In the case of different audio languages, the stream with the selected language is selected. The same procedure is applied if subtitles in different languages are present in the stream. FIG. 1 only shows the video elementary stream and a graphics elementary stream, e.g. a subtitle (ST) elementary stream, for illustrative and clarity purposes. If there is an interactive graphics stream, then there is often a third plane on top of the video plane 13 and the subtitle plane 14. The elementary streams are decoded in separate decoders for video 11 and graphics 12. The decoders also contain a buffer in which the information is stored until it is to be presented, when the picture 15 is created by superimposing the decoded video plane 13 and the decoded graphics plane.

FIG. 2 illustrates that all information from a certain picture must have been transmitted before it can be decoded and presented. The reference pictures must have been decoded before the B (and P) picture can be decoded.

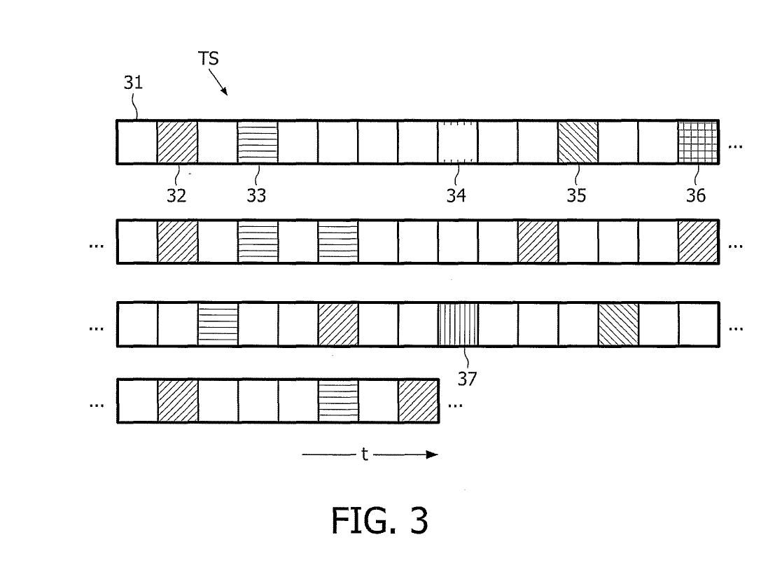

FIG. 3 gives an example of successive TS packets. Exemplary TS packets from the following elementary streams are shown: Video 31, Audio-1 32, Audio-2 36, Interactive Graphics (IG) 34, Subtitling (ST) 36, and furthermore SI information 37. Very often there is more than one graphics stream, e.g. for different languages.

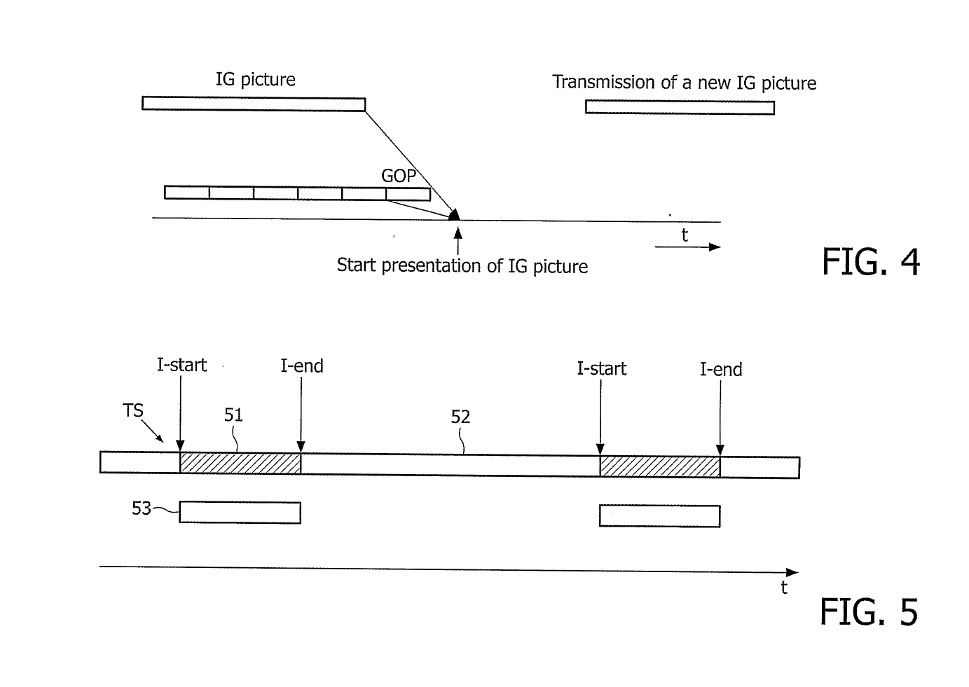

FIG. 4 shows the conventional case in which graphics information of a graphics picture is distributed over several GOP intervals, and the start of transmission of the graphics picture may be seconds or even minutes before the actual presentation of the graphics picture.

Conventionally, as mentioned in the preamble, only part of the stream is read during trick play, i.e. only the I-pictures. This means that only part of the Interactive Graphics (IG) and/or Subtitles (ST) streams is conventionally read, as the graphics information is distributed along the entire TS. Hence, some IG/ST TS packets are missing during conventional trick play. This makes the complete IG/ST streams useless because no IG/ST picture can be presented during trick play. After trick play it may take minutes before the new IG/ST picture is available, as mentioned above.

According to an embodiment of the invention, the graphics TS packets (IG and/or ST) are multiplexed only in the stream when the I-picture is being multiplexed. Thus the complete graphics streams is read during trick play, and there will be no missing packets. The graphics may be presented during trick play and are available immediately after trick play is changed to normal play.

FIG. 5 shows a preferred embodiment of a video signal TS authored by an embodiment of the authoring method according to the invention, wherein the graphics information is only multiplexed in intervals of a TS in which an I-picture 51 is multiplexed in the stream TS. During trick play only those parts 53 of the transport stream TS are read which contain I-picture data. The CPI table is used for this purpose. Here the start location in the stream and the length of the I-picture are given. According to the invention, graphics data is exclusively multiplexed in the intervals 51 of the TS comprising I-pictures. In the intervals 52 comprising B+P pictures, no graphics data is multiplexed. Hence, the complete graphics data is accessible and available for further processing during trick play.

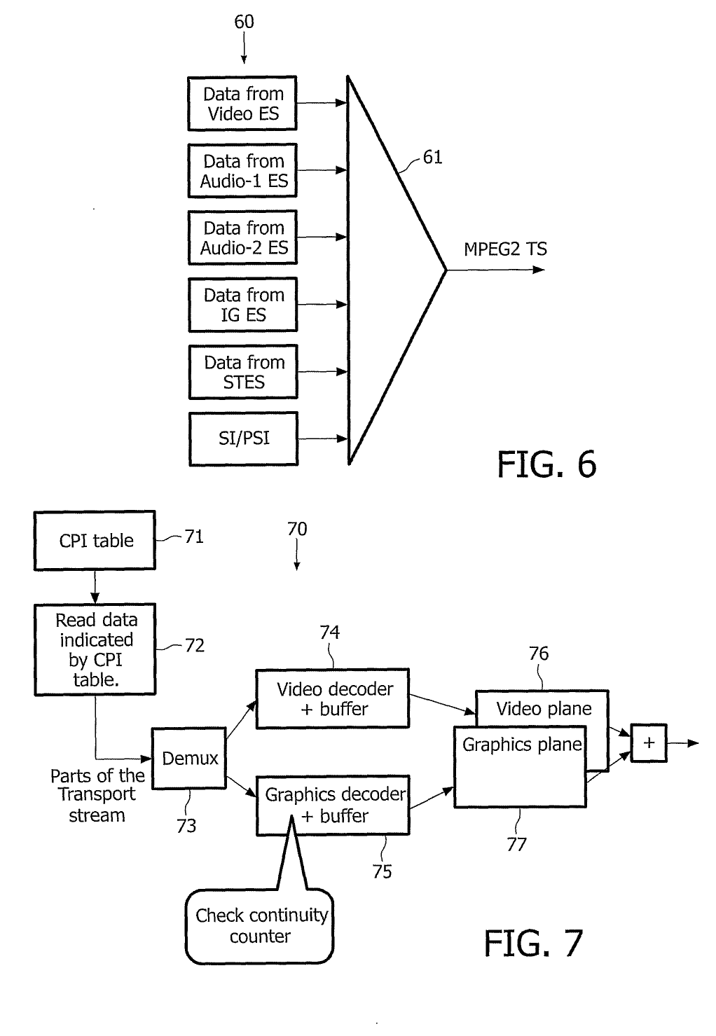

When authoring a video signal according to an embodiment of the authoring method of the invention, transport stream packets from elementary streams from video, audio, presentation and interactive graphics are all multiplexed by means of a multiplexer 61 in one MPEG2-Transport Stream. The following multiplexing rules are to be followed during authoring of the TS, supported by the illustration in FIG. 6:
Each elementary stream gets its own PID number.
Buffer requirements for each elementary stream are taken into account, which means that buffer underflow or overflow in the decoding buffers is avoided.
Each access unit has a PTS (Presentation Time Stamp) (and DTS (Decoding Time Stamp)).
The maximum bit rate (averaged in the transport buffer) has a maximum value that depends on the kind of elementary stream (40 Mbps for video, 2 Mbps for audio, 1 Mbps for system data).
The multiplexing rate of the graphics streams is rather low. This means that the graphics stream for displaying one picture is distributed over several frame intervals, as is illustrated in FIG. 4.
The graphics picture is refreshed after a time, this time interval may be large (up to several minutes), see also FIG. 4.
During trick play only part of the stream is read. Very often only the I pictures are read. The CPI information is used for this, which indicates both the start location (I-start) and the end of the I-picture (I-end) in the MPEG Transport stream.
No graphics data, or other data relevant for processing of the graphics, is multiplexed in the stream during intervals in which P and B pictures are being multiplexed in the stream.
The CPI table is derived and also stored on a digital storage medium, such as an optical disc or a hard disk, if the TS is stored.

Data from elementary streams 60 is present in buffers or available from a digital storage medium, such as a harddisk or an optical disc. The general multiplexing rules given above are followed during multiplexing of the TS packets of the elementary stream into one MPEG2 Transport stream. One additional rule is applied, this is about multiplexing the graphics elementary stream only in the multiplex during the interval in which the I-frame is being multiplexed in the stream. This rule is applied to all elementary streams for which this is appropriate.

In another embodiment of the invention shown in FIG. 7, a video player 70 uses the CPI table 71 during trick play, being played back from a TS authored according to the authoring method described above, in order to read only those parts from the TS where data from I-pictures is present. This selection is performed by CPI selector means 72. Thus only the relevant streams are filtered in the Demux 73. The continuity counter in the MPEG2 TS pictures is monitored to check that no packets are missing. Graphics and video are decoded by decoders 74, 75, respectively, and buffered, if so desired. Then the decoded video picture 76 and the superimposed decoded graphics picture 77 are shown at the presentation interval which corresponds to the presentation times of the I-pictures. Hence, trick play is enabled with undisturbed presentation of graphics during trick play and immediately after ending trick play.

According to a further embodiment of the invention, a digital storage medium is provided having a multiplexed video signal recorded on it, wherein the video signal is authored according to the authoring method described above with reference to FIG. 6. The digital medium is preferably a harddisk mass storage device or an optical disk, such as a DVD or BD-ROM.

Applications and use of the trick play related methods described above, apparatuses, programs, and digital media according to the invention are various and include exemplary fields such as movies for distribution on optical discs like DVD or BD-ROM. Here care has been taken during authoring in the studio that graphics data is only multiplexed into the intervals in which the I-pictures are transmitted.

It may also be used in personal authoring of own recordings. The authoring software tools take care that the graphics data is only multiplexed in the stream during intervals in which an I-picture is transmitted.

It may even be used for broadcast signals. In this case the actions are taken in the broadcasting studio.

The above description refers to graphics streams which may be presentation graphics or interactive graphics. It is easy to understand that the same technique can also be applied to so-called SI (Service Information) TS packets as specified for broadcast signals and PSI (Program Specific Information) as specified in MPEG.

The present invention has been described above with reference to specific embodiments. However, embodiments other than the preferred ones discussed above are equally possible within the scope of the appended claims, e.g. multiplexing orders different from those described above, performing the above method by hardware or software, etc.

Furthermore, the term “comprises/comprising” when used in this specification does not exclude other elements or steps, the terms “a” and “an” do not exclude a plurality, and a single processor or other units may fulfill the functions of several of the units or circuits recited in the claims.

1. A method of authoring a digital video signal comprising graphics content in a multiplex stream, said method comprising constructing said signal during authoring, and multiplexing said graphics content exclusively into the frame of at least a first type of image multiplexed into the stream.

2. The method according to claim 1, wherein said digital video signal is an MPEG-2-compatible signal.

3. The method according to claim 1, wherein said first type of image is an I-picture coded without reference to the other pictures in the stream.

4. The method according to claim 1, wherein said graphics is presentation graphics or interactive graphics.

5. The method according to claim 4, wherein the presentation graphics comprises subtitles.

6. The method according to claim 4, wherein the interactive graphics comprises menus.

7. A trick play method for a digital video signal comprising graphics content authored according to claim 1, said method comprising reading a selected number of a first type of images from a source multiplex stream during trick play as a source for displaying said trick play, and reading said graphics content that was multiplexed into said first type of images together with said first type of images.

8. An apparatus for authoring a digital video signal comprising graphics content in a multiplex stream, said apparatus being adapted to perform the method according to claim 1.

9. An apparatus for trick play of a digital video signal comprising graphics content, said apparatus being configured to perform the method according to claim 7.

10. A computer-readable medium having embodied thereon a computer program for processing by a computer, the computer program comprising code segments for authoring a digital video signal comprising graphics content in a multiplex stream, said computer program being configured to perform the method according to claim 1.

11. A computer-readable medium having embodied thereon a computer program for processing by a computer, the computer program comprising code segments for trick play of a digital video signal comprising graphics content in a multiplex stream, said computer program being configured to perform the method according to claim 7.

12. A digital video signal comprising graphics content, said signal comprising a selected number of a first type of coded images in a transport stream, wherein said graphics content is exclusively multiplexed into said first type of images.

13. A multiplexed digital video signal authored by the method according to claim 1.

14. The digital video signal according to claim 12, wherein the signal is stored on a digital storage medium.

15. The digital video signal according to claim 12, wherein the signal is configured to be broadcast.

16. A digital storage medium having the signal according to claim 12 stored on it.
